(19) United States
(12) Patent Application Publication
(10) Pub. No.: US 2016/0364743 A1
(43) Pub. Date: Dec. 15, 2016

(54) DATA ENHANCEMENT ANALYSIS WITH RESPECT TO MERCHANTS' CUSTOMER LOYALTY ACCOUNTS

(71) Applicant: MasterCard International Incorporated, Purchase, NY (US)

(72) Inventors: Lindsay St. Lawrence, Rye Brook, NY (US); Pamela Veraart, Manhasset, NY (US); Steven Oshry, Tarrytown, NY (US); Adam Slackman, New York, NY (US); Luckner Polycarpe, Brooklyn, NY (US)

(21) Appl. No.: 14/737,017

(22) Filed: Jun. 11, 2015

(51) Int. Cl. G06Q 30/02; G06Q 20/38

(52) U.S. Cl. CPC G06Q 30/0233; G06Q 20/387

(57) ABSTRACT

A first set of transaction data is received from a merchant. The first set of transaction data represents a plurality of customer profiles. Each of the customer profiles corresponds to a respective account in a customer loyalty program administered by the merchant. A second set of transaction data is received from the merchant. The second set of transaction data represents unattached transactions involving the merchant but not associated by the merchant with any of the customer loyalty program accounts. Payment account numbers associated with the unattached transactions are used to link ones of the unattached transactions to respective ones of the customer loyalty program accounts.

### FIELD

Embodiments relate to transaction processing systems and methods. More particularly, embodiments relate to the matching and analysis of transaction data from different sources without exposing any personally identifiable information.

### BACKGROUND

Payment processors, networks and other entities create and process large amounts of spending and payment-related data each day. The data is collected and stored to support transaction processing, and other purposes related to ensuring that parties involved in a transaction are properly compensated. The data has other potential uses as well, including for use in identifying and analyzing spending patterns and behaviors. However, when the payment data is used for such analysis purposes, it is important that the transaction details be “de-identified” from any private or personally identifiable information, or that strict limitations on use of and access to the data must be maintained.

It would be desirable to provide systems and methods which allow the analysis of large volumes of transaction data using de-identified data sets. Further, it would be desirable to provide a linkage method between data from one data source (such as a merchant's sales ledger) to transaction data from a second data source (such as a payment network), thereby providing an ability to construct analyses, reports and other applications based on the matched data sets.

The present inventors have also recognized opportunities to resolve “blind spots” that may exist in merchants' data with respect to the loyalty accounts they maintain for their customers.

### BRIEF DESCRIPTION OF THE DRAWINGS

FIG. 1 illustrates a system architecture within which some embodiments may be implemented.

FIG. 2 is a flow diagram depicting a process pursuant to some embodiments.

FIG. 3 is a flow diagram depicting a process pursuant to some embodiments.

FIGS. 4A and 4B are block diagrams depicting data tables pursuant to some embodiments.

FIG. 5 is a block diagram depicting a matching table pursuant to some embodiments.

FIG. 6 is a block diagram depicting a portion of an example output analysis pursuant to some embodiments.

FIG. 7 is a block diagram depicting a computer system that may form part of the system shown in FIG. 1.

FIG. 8 is a flow chart that illustrates a process for calculating probability scores.

FIG. 9 is a diagram that illustrates a system that may be related to the system shown in FIG. 1, and that may be provided in some embodiments.

FIG. 10 is a block diagram depicting a computer system that may form part of the system shown in FIG. 9.

FIGS. 11-13 are diagrams that schematically illustrate processes that may be performed in the system of FIG. 9 in some embodiments.

FIG. 14 is a flow chart that illustrates a process that may be performed in the system of FIG. 9 in some embodiments.

### DETAILED DESCRIPTION

Embodiments of the present invention relate to systems and methods for analyzing transaction data. More particularly, embodiments relate to systems and methods for analyzing transaction data using data from a first transaction data provider (e.g., such as a payment card network) and data from a second transaction data provider (e.g., such as a merchant or group of merchants) in a way which ensures that personally identifiable information (“PII”) is not revealed or accessible during or after the analysis.

In some embodiments, analysis may involve a data set of transactions attached to customer loyalty account profiles, and another data set of transactions that are not attached to any loyalty account profile. One aspect of analysis may eliminate duplicate loyalty accounts, by linking account profiles to each other, and combining the linked profiles. Another aspect of analysis may link unattached transactions to loyalty account profiles, thereby building more complete records of customer behavior. Still another aspect of analysis may form pseudo-loyalty-account profiles from unattached transactions that have not been linked to any loyalty account profile, but that were charged to the same payment account.

A number of terms are used herein. For example, the term “de-identified data” or “de-identified data sets” are used to refer to data or data sets which have been processed or filtered to remove any PII. The de-identification may be performed in any of a number of ways, although in some embodiments, the de-identified data may be generated using a filtering process which removes PII and associates a de-identified unique identifier (or de-identified unique “ID”) with each record (as will be described further below).

The term “payment card network” or “payment network” is used to refer to a payment network or payment system such as the systems operated by MasterCard International Incorporated, or other networks which process payment transactions on behalf of a number of merchants, issuers and cardholders. The terms “payment card network data” or “network transaction data” are used to refer to transaction data associated with payment transactions that have been processed over a payment network. For example, network transaction data may include a number of data records associated with individual payment transactions that have been processed over a payment card network. In some embodiments, network transaction data may include information identifying a payment device or account, transaction date and time, transaction amount, and information identifying a merchant or merchant category. Additional transaction details may be available in some embodiments.

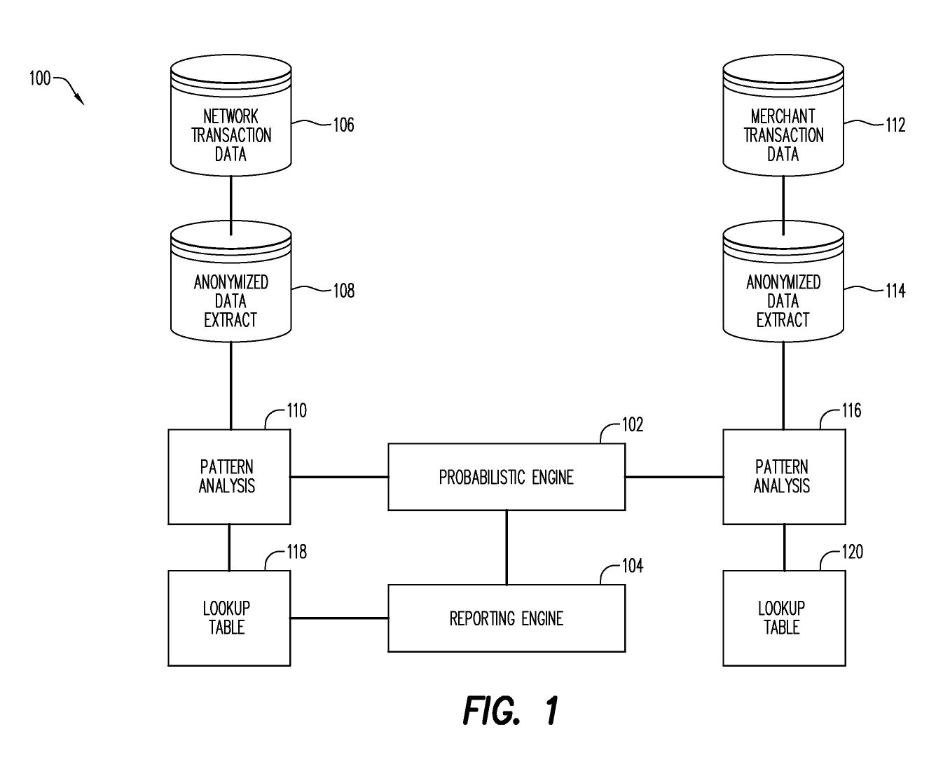

Features of some embodiments of the present invention will now be described by first referring to FIG. 1 where a block diagram of portions of a transaction analysis system 100 are shown. The transaction analysis system 100 may be operated by or on behalf of an entity providing transaction analysis services. For example, in some embodiments, system 100 may be operated by or on behalf of a payment network or association (e.g., such as MasterCard International Incorporated) as a service for entities such as member banks, merchants, or the like.

System 100 includes a probabilistic engine 102 in communication with a reporting engine 104 to generate reports, analyses, and data extracts associated with data matched by the probabilistic engine 102. In some embodiments, the probabilistic engine 102 receives or analyzes data from several data sources, including network transaction data 106 (e.g., from payment transactions made or processed over a payment card network) and merchant transaction data 112 (e.g., from purchase transactions conducted at one or more merchants). The data from each data source 106, 112 is pre-processed before it is analyzed using the probabilistic engine 102. In some embodiments, the data is used to first create an anonymized data extract 108, 114 in which any PII is removed from the data. Pursuant to some embodiments, the anonymized data extract 108, 114 is created by generating a de-identified unique identifier code that is derived from a unique transaction identifier of each transaction in the source data 106, 112. For example, with respect to the network transaction data 106, a function may be applied to a transaction identifier associated with each transaction and transaction record to create a de-identified unique identifier associated with each transaction. In some embodiments, the function may be a hash function or other function so long as the unique identifier cannot by itself be linked to the individual transaction record (for example, an entity that has access to the anonymized data extract 108 is not able to identify any PII associated with a de-identified unique identifier in the extract 108).

The merchant transaction data 112 may be provided to an entity operating the system of the present invention via a secure file transfer (e.g., via sFTP or the like) and associated with a unique merchant identifier. The merchant transaction data 112 may include sales ledger data in a pre-defined format that contains information associated with a plurality of transactions conducted at the merchant including, for example, transaction date/time/spend, store location and a unique identifier associated with the transaction (such as, for example, a customer unique identifier). In some embodiments, the customer unique identifier (“UID”) is selected such that it is not personally identifiable (although it may be personally identifiable with additional information known to the merchant). The customer UID, in some embodiments, is delivered using a de-identified unique identifier generated from the transaction data received from the merchant point of sale systems for continuity between transactions, and is selected to be persistent across transactions. For example, the customer UID may show up numerous times throughout a file provided by a merchant (e.g., the UID may be associated with transactions performed at different store locations, at different times, and with different transaction amounts). In some embodiments, the merchant data extract is tender agnostic, and includes transactions conducted with cash, payment cards, or the like. In general, the number of merchant transactions in the merchant data extract should be higher than the number of payment network transactions extracted by data extract 108 for the merchant as the merchant data extract includes transactions conducted with different tenders including payment network transactions. In some embodiments, the UID may stand in for a customer loyalty account number that is known to the merchant and that corresponds to a given individual customer or household.

Pursuant to some embodiments, the type of data extracted by modules 108, 114 depends on the type of information to be analyzed by the system 100. For example, the data extract 108 may be an extract of the same type of information to be provided by a merchant in data extract 114 (e.g., such as transaction date and time, transaction amount, store location and frequency data). In some embodiments, the data extract may be a sample of a larger set of data, or it may be an entire data set. Further, when extracting payment network data (at 108), information associated with the merchant for which an analysis is to be performed may be used to limit the extract. For example, if an analysis is to be performed for a specific merchant, the extract 108 may be limited to transactions performed at that specific merchant (including all locations or all locations in a specific geographical region). As a specific illustrative example, extract 108 may include a number of records of data, each including a de-identified unique ID, a transaction date, a transaction time, a transaction amount or spend, a store location identifier (identifying a specific store or merchant location), and an aggregate merchant identifier (identifying a specific merchant chain or top level identifier associated with a merchant). Those skilled in the art, upon reading this disclosure, will appreciate that other data fields may also be included depending on the nature of the analysis to be performed.

With respect to the data extract 114 of merchant transaction data 112, in some embodiments, the extract retrieves data elements including a customer UID, a transaction date, a transaction time, a transaction spend, and a store location ID (although those skilled in the art will appreciate that additional or other fields may be extracted depending on the nature of the analysis to be performed).

In some embodiments, the function or process of generating an anonymized data extract 108, 114 may be performed by an entity providing the data. For example, the anonymized data extract 108 may be generated by, or on behalf of, the payment association or the payment network and provided as an input or batch file to an entity operating system 100. As another example, the anonymized data extract 114 may be generated by, or on behalf of, a merchant (or group of merchants) wishing to receive reports or analyses from the system 100.

The system 100 also includes pattern analysis modules 110, 116. Pattern analysis modules 110, 116 may include data, rules or other criteria which define different patterns identified for analysis. Each pattern may be identified by a unique pattern identifier which may be, for example, a random number. Each pattern may be a unique pattern of date/time/spend, store location, and transaction frequency (or other combinations of data for which pattern analysis is desired). The pattern analysis modules 110, 116 may be code or applications which are designed for pattern analysis or may be part of an analysis system or module.

In use, pattern analysis module 110 generates a file, table or other extract of data that is used as an input to the probabilistic engine 102 and which is based on the anonymized and extracted network transaction data. The pattern analysis module 110 may be operated to generate a file, table or other extract of data that includes a number of transactions filtered by an aggregate merchant identifier (e.g., a group of transactions associated with a particular merchant or retail chain across different stores or locations). The module 110 may also summarize and profile the data by each unique combination of transaction date/time/spend, location, and frequency. A new profile identifier may be assigned for each pattern, and the data provided for input to the probabilistic engine 102 may have the de-identified unique ID removed before provision to the engine 102. In some embodiments, the removed unique ID and the assigned profile identifier may be stored in a separate lookup table 118 for later use by the reporting engine 104.

The pattern analysis module 116 generates a file, table or other extract of merchant transaction data that is used as an input to the probabilistic engine 102 and which is based on the anonymized and extracted merchant transaction data provided by module 114. The pattern analysis module 116 may be operated to generate a file, table or other extract of data which has been cleansed to ensure standard formatting of the merchant data for use by the probabilistic engine 102. The cleansing may include the removal of any unnecessary data provided by the merchant. For example, in one specific embodiment, the merchant data may be cleansed to remove all fields other than a customer UID, a transaction date, a transaction time, a transaction spend, and a location ID. The pattern analysis module 116 may further operate to summarize the data by UID to ascertain a frequency of transactions in the merchant data file, and to further summarize and profile data by each combination of transaction date/time/spend, location, and frequency. Upon generation of the extract, a new merchant profile identifier may be assigned to the extract. The merchant profile identifier and the UID are removed from the file output from the pattern analysis module 116. A separate lookup table 120 may be created to store the dropped UID and the merchant profile identifier for later use by the reporting engine 104.

Pursuant to some embodiments, the probabilistic engine 102 operates to perform an inferred match analysis to assess the inferred linkage for uniqueness and direct linkage. This allows further assurance of anonymity and avoids use of any PII. Pursuant to some embodiments, a uniqueness probability is derived from the relationship between the number of unique IDs for the Network Profile and the unique Merchant Profiles. As the probability of a direct link, (driven by uniqueness), approaches 100%, the risk of divulging or revealing some PII increases. For data analysis to identify product or marketing effectiveness, a pattern match of 100% is ideal. However, as the uniqueness of the match approaches 0%, the product or marketing effectiveness decreases significantly. By using features of the present invention to identify the uniqueness probability using anonymized transaction data, embodiments allow marketers, product developers, and analysts to identify trends or actual patterns and to adjust marketing, product development and other features accordingly.

In general, as used herein, the term “direct linkage” refers to the relationship between the probability match and the uniqueness probability. 100% “direct linkage” occurs when the probability match is 100% and the uniqueness probability is 100%. To avoid potentially revealing PII, in some embodiments, it may be desirable to reject any matches where there is 100% direct linkage. Pursuant to some embodiments, the primary inferred match is those records having the highest probabilities within a predetermined acceptance range.

Pursuant to some embodiments, the output of the processing performed by system 100 may be an analysis or report which is generated by the reporting engine 104. To facilitate the reporting and to ensure that PII is not divulged, the reporting engine may use the lookup tables 118, 120 to assign each de-identified merchant profile (from table 120) to one network profile (from table 118). This ensures that the de-identified customers remain de-identified.

As used herein, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. In addition, entire modules, or portions thereof, may also be implemented in programmable hardware devices such as field programmable gate arrays, programmable array logic, programmable logic devices or the like or as hardwired integrated circuits.

In some embodiments, the modules of FIG. 1 are software modules operating on one or more computers. In some embodiments, control of the input, execution and outputs of some or all of the modules may be via a user interface module (not shown) which includes a thin or thick client application in addition to, or instead of a web browser.

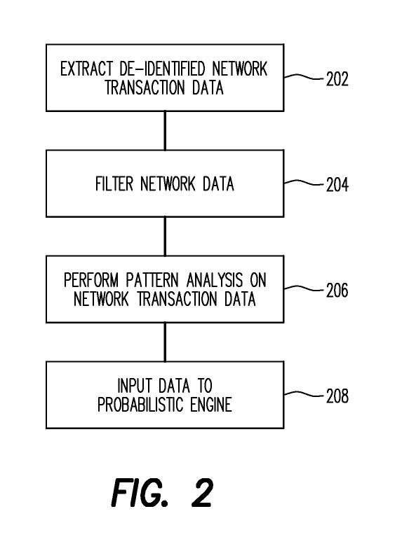

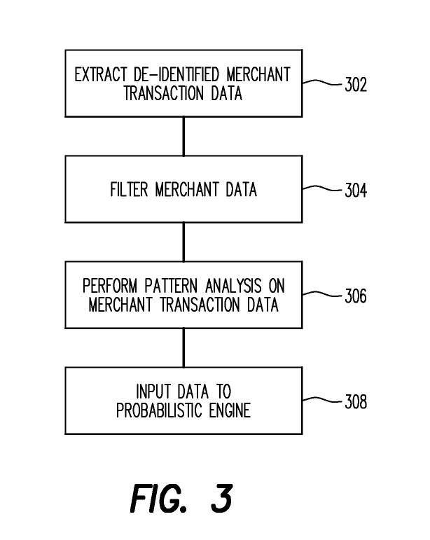

Reference is now made to FIGS. 2-3 which are flow diagrams depicting processes 200, 300 for operating the system 100 of FIG. 1 pursuant to some embodiments. Some or all of the steps of the processes 200, 300 may be performed using under control of the system 100 and may include users or administrators interacting with the system via one or more user devices (not shown).

In the process 200, network transaction data is extracted from a transaction datastore 106 and a pattern analysis is performed to produce a file for input to probabilistic engine 102. The process 200 begins at 202 where a payment network data extract is performed to provide de-identified data from the payment network associated with a particular merchant or group of merchants. The de-identified data extract may include an extract of fields for payment network transactions, including: a de-identified unique ID (generated as described above), an aggregate merchant ID, a transaction date, a transaction time, a transaction spend, and a location ID. In the case where the payment network is the network operated by MasterCard International Incorporated, the data extract will include a number of transactions conducted using MasterCard-branded payment cards.

Processing continues at 204 where the de-identified data extracted at 202 is filtered, producing a filtered output file having a number of transactions for a particular merchant or group of merchants, resulting in a file of payment network transactions conducted at those merchants and each including: a de-identified unique ID, a transaction date, a transaction time, a transaction spend, and a location ID.

Processing continues at 206 where a pattern analysis is performed to identify a frequency of transactions. The pattern analysis may result in the creation of a file including, for each transaction, a de-identified unique ID, a transaction date, a transaction time, a transaction spend, a location ID, and a frequency variable.

Processing continues at 208 where data is provided to the probabilistic engine 102 including a number of transactions each including a number of fields such as: transaction date, transaction time, transaction spend, a location ID, a frequency variable, and a profile ID. The profile ID is associated with an entry in a lookup table created to store the profile ID in association with the de-identified unique ID for each transaction. In this way, data may be input to the probabilistic engine 102 without any identifier (e.g., the de-identified unique ID is removed from the data input to the probabilistic engine 102, and instead a lookup is provided external to the probabilistic engine 102).

Similar processing is performed on the merchant data. For example, as shown in FIG. 3, a process 300 is performed which starts at 302 with the extraction of de-identified merchant data, including a number of transactions (across different tenders) conducted at the merchant. The transaction data includes: a customer UID, a transaction date, a transaction time, a transaction spend, a location identifier, and, in some embodiments, a tender flag (which identifies the form of tender used in each transaction).

The data extract from 302 is then filtered and cleansed at 304 to produce a data file including, for each transaction in the extract, a customer UID, a transaction date, a transaction time, a transaction spend and a location ID.

Processing continues at 306 where the filtered data from 304 is processed using a pattern matching system to derive frequency data associated with the filtered and extracted merchant data. The pattern matching causes the creation of a file having, for each transaction, a customer UID, a transaction date, a transaction time, a transaction spend, a location ID and a frequency variable. A portion of this data is provided as the merchant input to the probabilistic engine 102 at 308, including, for each transaction, a transaction date, a transaction time, a transaction spend, a location ID, a frequency, and a merchant profile ID. The merchant profile ID is associated with a lookup table that is created to associate the customer UID with the pattern or data output at 306. In this way, merchant transaction data may be input to the probabilistic engine 102 without any customer identifier (e.g., the customer UID is removed from the data input to the probabilistic engine 102, and instead a lookup is provided external to the probabilistic engine 102).

By providing such anonymized data to the probabilistic engine 102, a number of analyses and reports may be generated without revealing any PII or other sensitive information. For example, the probabilistic engine 102 may be operated to establish a linkage between a merchant's sales ledger and the de-identified payment network transaction data. The linkage is a probability score between the merchant data and the payment network transaction data based upon spending patterns provided by the merchant along with spending patterns observed in the payment network transaction data. The linkage, on its own, does not necessarily provide any intrinsic value; however, the inferred match is a necessary component to build out merchant applications by providing a link (on a transaction level) between a merchant data file and a payment network data file. As a result, merchants may enjoy the use of a number of analytic and modeling applications including the ability to generate aggregate reports, probability scores and model algorithms.

The two inputs provided to the probabilistic engine 102 include profiles at the network profile level (from pattern analysis 110) and profiles at the merchant profile level (from pattern analysis 116). The profiles may range in quantity of unique accounts (e.g., unique records associated with an account, or the like) from x to 1, and unique transactions from >x to 1.

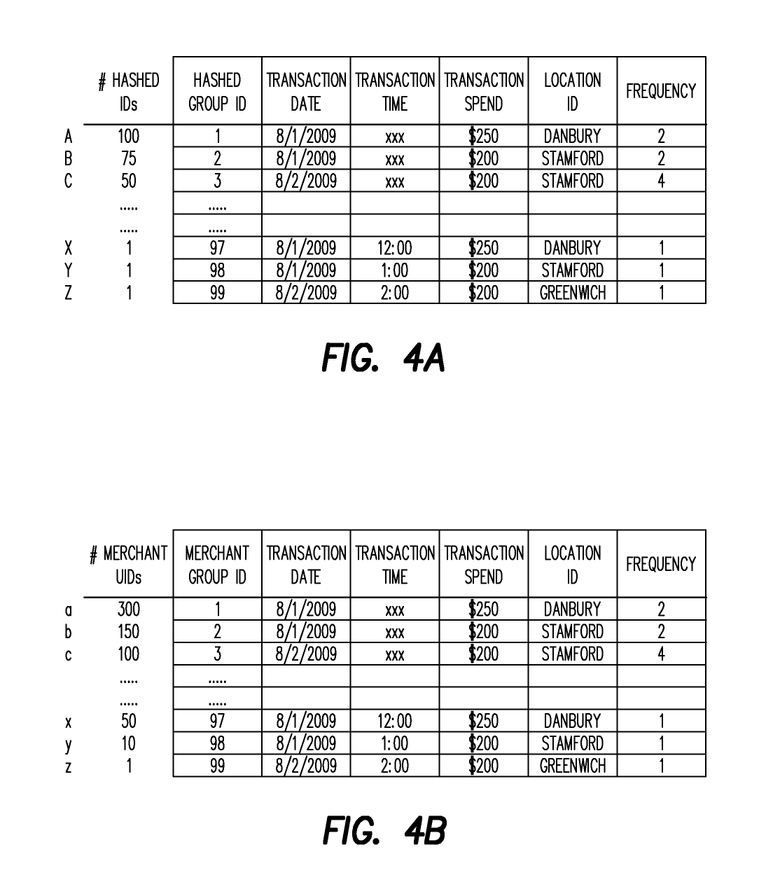

An illustrative example of a portion of data associated with a network profile is shown in FIG. 4A, and FIG. 4B illustrates a portion of data associated with an example table showing a profile at the merchant profile level pursuant to some embodiments.

Pursuant to some embodiments, the probabilistic engine 102 operates to match the merchant profile data with the network profile data with some level of probability. The level of probability, as used herein, is referred to as “the pattern match”. The pattern match could range from 0 to 1 (i.e., 0 to 100%). In addition to the pattern match, the probability of uniqueness could range from 0 to 1.

Network profiles and merchant profiles are linked in a many-to-many fashion and given some level of probability for each pattern match (e.g., 100 network profiles and 100 merchant profiles result in 10,000 probabilities). The match may not be exact—for example, the network profile may say that the spending associated with a specific transaction involved a credit card payment, while the merchant record may have a profile that indicates that the transaction was a cash transaction. These discrepancies may be matched and assigned a match probability. The linking is not actual—instead, a probability match is assigned ranging from 0 to 1 for each combination of records. An illustration of the many-to-many pattern match is shown in FIG. 5. In the illustrative example of FIG. 5, a match analysis is shown associated with an analysis performed using the system of FIG. 1 where the network transaction data is from a specific payment network—the network operated by MasterCard International Incorporated. In the illustrative match shown in FIG. 5, a “MasterCard Profile A” matches to a “Merchant Profile a” with a probability of 100%. Further, “Profile B” matches to “Profile b” with a probability of 100%, and so forth, because the patterns are identical. Other combinations are not identical, and therefore have a match probability of less than 100%.

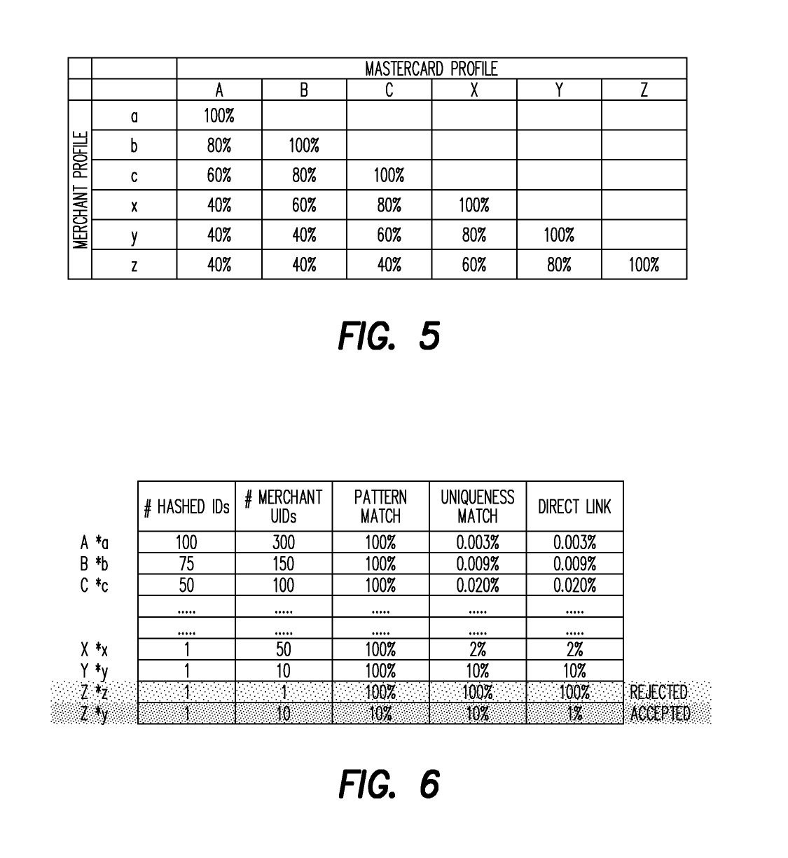

FIG. 6 illustrates an example output of the inferred match process pursuant to some embodiments. The probabilities and acceptance scores are purely for illustrative purposes and are not intended to be limiting. The output of the inferred match process may be produced or manipulated by the reporting engine 104 for use by other applications.

Pursuant to some embodiments, the operation of the system 100 may be based on several assumptions or rules to protect PII. Such assumptions or rules may include ensuring that the combined data set (including network data and merchant data) is not disclosed to the merchant, all applications are specific to a merchant and are not to be shared with other parties, algorithms or scores are created using matched data and no algorithm or score is created using single transaction matches.

Pursuant to some embodiments, the techniques described above may be used in conjunction with a number of different applications. For example, in one embodiment, an aggregated report is produced based on a merchant data file, with an inferred match modeling link to different merchant unique identifiers. In some embodiments, enhanced and aggregated reports may be produced, with inferred match links to merchant unique identifiers utilizing additional “SKU” data from the merchant (e.g., where the SKU level data is received in the merchant transaction data at 112). In some embodiments, data append services may be delivered at the de-identified merchant unique identifier level. Data may be produced as an aggregated metric/probability score. Further, pursuant to some embodiments, an algorithm may be provided designed to score a list outside of a payment network (e.g. for or about a merchant or other third party).

Thus, embodiments of the present invention allow merchants, networks, and others to accurately generate and investigate transaction profiles, without need for added controls to protect and secure PII. Although a number of “assumptions” are provided herein, the assumptions are provided as illustrative but not limiting examples of one particular embodiment—those skilled in the art will appreciate that other embodiments may have different rules or assumptions.

Pursuant to some embodiments, systems, methods, means, computer program code and computerized processes are provided to generate inferred match or linkage between de-identified data in different transaction data sets. In some embodiments, the systems, methods, means, computer program code and computerized processes include receiving a first set of de-identified transaction data from a first transaction data source, receiving a second set of de-identified transaction data from a second transaction data source, filtering the first and second sets of de-identified transaction data to identify transactions associated with at least a first entity and to create first and second filtered data sets, removing data associated with an identifier field for each of the transactions in the first filtered data set to create a de-identified first data set, removing data associated with an identifier field for each of the transactions in the second filtered data set to create a de-identified second data set, and processing the first and second de-identified data sets using a probabilistic engine to establish a linkage between data in each data set.

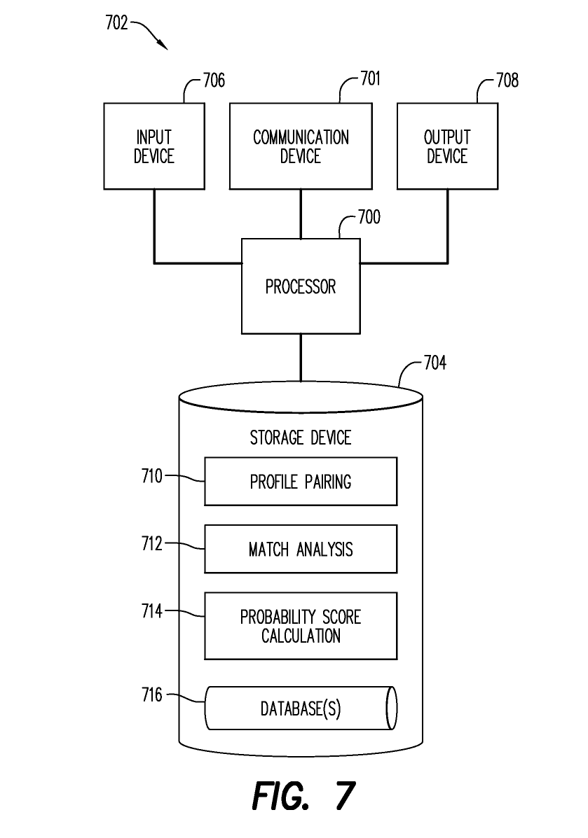

FIG. 7 is a block diagram depicting a computer system 702 that may form part of the system 100 shown in FIG. 1. The computer system 702, in particular, may implement an embodiment of the probabilistic engine 102 shown in FIG. 1. In some embodiments, the computer system 702 may implement other processing functions of the system 100 in addition to the probabilistic engine 102.

The computer system 702 may be conventional in its hardware aspects but may be controlled by software to cause it to operate in accordance with aspects of the present invention. For example, the computer system 702 may be constituted, at least in part, by conventional mainframe and/or server computer hardware.

The computer system 702 may include a computer processor 700 operatively coupled to a communication device 701, a storage device 704, an input device 706 and an output device 708. The storage device 704, the communication device 701, the input device 706 and the output device 708 may all be in communication with the processor 700.

The computer processor 700 may be constituted by one or more conventional processors. Processor 700 operates to execute processor-executable steps, contained in program instructions described below, so as to control the computer system 702 to provide desired functionality.

Communication device 701 may be used to facilitate communication with, for example, other devices (such as one or more other components of the system 100 shown in FIG. 1). Communication device 701 may, for example, have capabilities for engaging in data communication over conventional computer-to-computer data networks.

Input device 706 may comprise one or more of any type of peripheral device typically used to input data into a computer. For example, the input device 706 may include a keyboard and a mouse. Output device 708 may comprise, for example, a display and/or a printer.

Storage device 704 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory.

Storage device 704 stores one or more programs for controlling processor 700. The programs comprise program instructions that contain processor-executable process steps of computer system 702, including, in some cases, process steps that constitute processes provided in accordance with principles of the present disclosure, as described in more detail below.

The programs may include one or more conventional operating systems (not shown) that control the processor 700 so as to manage and coordinate activities and sharing of resources in the computer system 702, and to serve as a host for application programs (described below) that run on the computer system 702.

The programs stored in the storage device 704 may also include a program or program module 710 that controls the processor 700 to enable the computer system 702 to assemble pairs of profiles, where each of the profile pairs consists of one merchant profile and one network profile. For example, as will be understood from the above discussion of FIG. 5, each data cell in FIG. 5 represents one such profile pair. In addition, the storage device 704 may store a program or program module 712 that controls the processor 700 to enable the computer system 702 to analyze each profile pair to determine to what extent there is matching of transactions between the two profiles in the profile pair.

Still further, the storage device 704 may a store a program or program module 714 that controls the processor 700 to enable the computer system 702 to generate the above referenced match probabilities (as seen in FIG. 5), which will also sometimes be referred to as the “probability score” that applies to the respective profile pair. Details of this program/program module 714 will be described below.

The storage device 704 may also store, and the computer system 702 may also execute, other programs, which are not shown. For example, such programs may include a reporting application, which may respond to requests from system administrators for reports on the activities performed by the computer system 702. The other programs may also include, e.g., one or more data communication programs, a database management program, device drivers, etc.

Reference numeral 716 in FIG. 7 indicates one or more databases that are maintained by the computer system 702 on the storage device 704. Among these databases may be databases of merchant profiles, network profiles, and profile pairs with appended probability scores.

The application programs of the computer system 702 as described above, may be combined in some embodiments, as convenient, into one, two or more application programs.

Additional details of operation of the computer system 702 are contained in commonly-assigned U.S. patent application Ser. No. 14/524,678, filed on Oct. 27, 2014, and published as U.S. Patent Publication No. 2016/______ (Atty docket no. M01.304), which patent application is incorporated herein by reference.

It will be noted that this embodiment of the probabilistic engine 102 works with two-way matching between network and merchant profiles, and may also base its calculations in part on matching of transactions to “nearest neighbor” profiles. A nearest neighbor profile, relative to a particular profile pair, is either (a) a network profile not included in the profile pair and having a transaction that matches a merchant transaction included in the merchant profile included in the profile pair, or (b) a merchant profile not included in the profile pair and having a transaction that matches a network transaction included in the network profile in the profile pair.

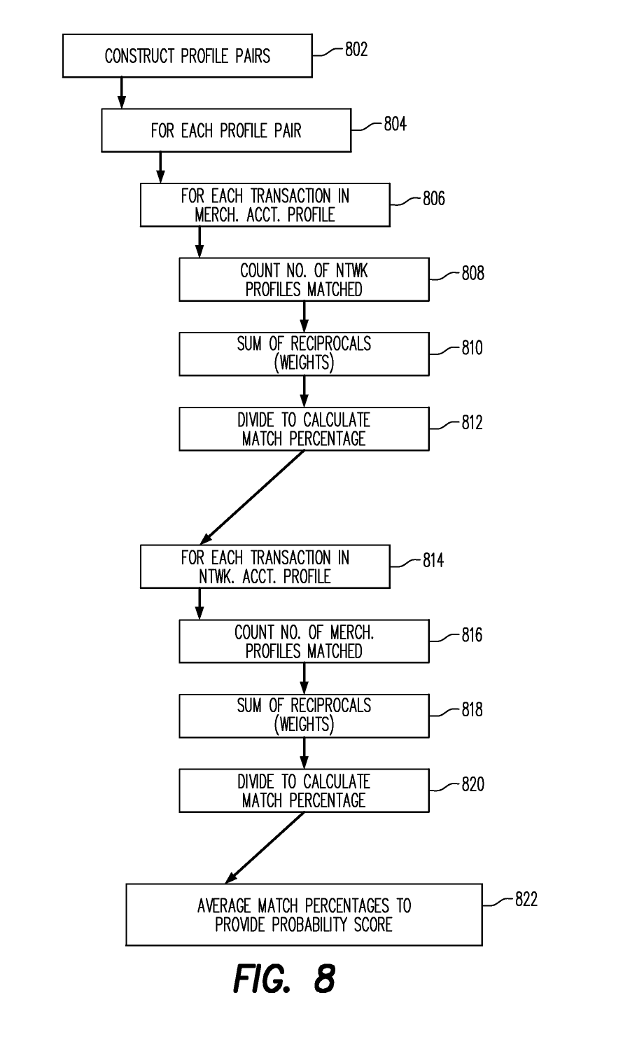

With reference to FIG. 8, there will now be a summary discussion of a manner of calculating a probability score. FIG. 8 is a flow chart that illustrates a process that may be performed by the computer system 702/probabilistic engine 102.

At 802 in FIG. 8, the computer system 702 assembles profile pairs, each of which consists of one merchant profile and one network profile. As suggested by prior discussion, in some embodiments, the total number of profile pairs assembled is the number of merchant profiles times the number of network profiles, with each merchant profile matched with each and every network profile to form the profile pairs.

Block 804 indicates that the subsequent stages of the process of FIG. 8 may be performed for each of the profile pairs, to generate a respective probability score for each of the profile pairs. Thus it can be assumed for the balance of the discussion of FIG. 8 that a particular profile pair has been selected for calculation of a probability score. It will of course be recalled that the profile pair consists of one of the merchant profiles and one of the network profiles. It will also be understood that each merchant profile includes one or more merchant transactions and each network profile includes one or more network transactions.

Block 806 indicates that the following block 808 is to be performed for each transaction included in the merchant profile in the current profile pair. At block 808, for the current merchant transaction, the computer system 702 counts the number of network profiles that are matched to the current merchant transaction.

At block 810, the computer system 702 calculates reciprocals of the counts generated at 808 for the merchant transactions, and then calculates a sum of the reciprocals, which are assigned as weights to the merchant transactions. The resulting sum may be referred to as a weight sum for the merchant profile for the current profile pair.

Next, at 812, the merchant profile weight sum is divided by the merchant transaction count, which is the number of merchant transactions included in the merchant profile, and hence associated with the current profile pair. The result of the division operation may be expressed as a percentage, which may be referred to as the merchant transaction match percentage for the current profile pair.

Block 814 indicates that the following block 816 is to be performed for each transaction included in the network profile in the current profile pair. At block 816, for the current network transaction, the computer system counts the number of merchant profiles that are matched to the current network transaction.

At block 818, the computer calculates reciprocals of the counts generated at 816 for the network transactions, and then calculates a sum of the reciprocals, which are assigned as weights to the network transactions. The resulting sum may be referred to as a weight sum for the network profile for the current profile pair.

Next, at 820, the network profile weight sum is divided by the network transaction count, which is the number of network transactions included in the network profile, and hence associated with the current profile pair. The result of the division operation at 820 may be expressed as a percentage, which may be referred to as the network transaction match percentage for the current profile pair.

At 822, the computer system 702 computes an average (mean) of the merchant transaction match percentage calculated at 812 and the network transaction match percentage calculated at 820. The resulting average may be expressed as a percentage and may be assigned to the current profile pair as the probability score for the current profile pair.

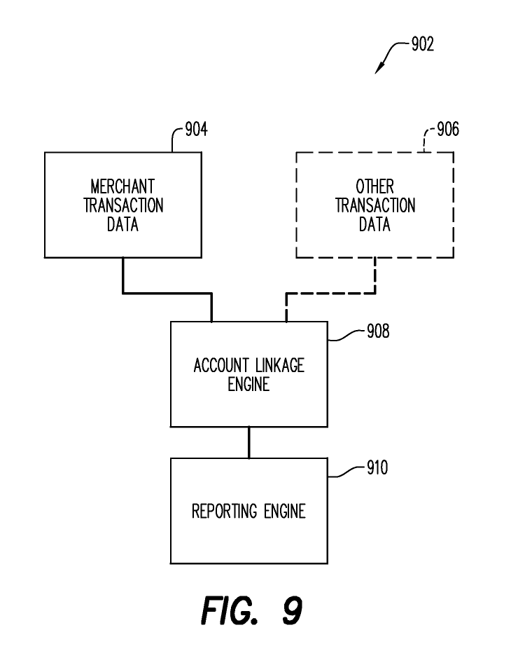

FIG. 9 is a diagram that illustrates a system 902 that may be related to the system shown in FIG. 1, and that may be provided in some embodiments. In some embodiments, components of system 902 may be included in and/or may overlap with the system components shown in FIG. 1.

Block 904 corresponds to an input of merchant transaction data. In some embodiments, the merchant transaction data may be data representing transactions performed at the merchant and attached/associated with specific customer loyalty accounts maintained by the merchant for its customers. In some embodiments, the merchant transaction data relating to transactions attached to specific customer loyalty accounts may be arranged in loyalty account profiles consisting entirely and only of all transactions associated at the point of sale (or in some other manner) with a respective one of the customer loyalty accounts maintained by the merchant.

In some embodiments, the merchant data may also include “unattached” transaction data, i.e., transaction data relating to transactions at the merchant that have not been associated with any of the customer loyalty accounts.

Unattached transactions represent a challenge to the merchant and/or a limitation on the merchant achieving its goals with respect to understanding its customers, particularly via analysis of its customers' loyalty accounts. Unattached transactions may represent transactions by customers who failed to provide information at the time of the transaction to tie the transaction to the customer's loyalty account. Alternatively, unattached transactions may represent transactions by customers who have not enrolled in the merchant's customer loyalty program. In some situations, at least some unattached transactions may be e-commerce (i.e., online purchase) transactions, whereas some unattached transactions may be in-store transactions. It may be the case, for at least some e-commerce unattached transactions, that the customer had a customer loyalty account with the merchant but did not or could not provide information to associate the e-commerce transaction with the customer's loyalty account. The unattached transactions represent potentially valuable information for the merchant, but the unattached nature of the transactions is a challenge to the merchant in terms of realizing the value of the information relating to the unattached transactions.

Furthermore, because fobs/cards that identify customers for the purposes of a customer loyalty program may be rather liberally distributed, it may be the case that the same customer/household may have been issued two or more different loyalty account numbers. Consequently, the corpus of customer loyalty account profiles may contain “duplicate” loyalty account profiles, in the sense that for a given individual/household there may be two or more loyalty account profiles (i.e. the transactions with the merchant by a given individual or household may be spread over two or more loyalty accounts). This characteristic of the merchant's data, if present, may also present challenges to the merchant relative to the merchant's goal of understanding its customer base.

For a large retailer with many store locations and an active customer loyalty program, it is quite likely that the retailer/merchant's transaction data may relate to a very large number (i.e., millions) of transactions, and that the challenges of duplicate loyalty accounts and/or a large number of unattached transactions are likely to be present and may adversely affect the merchant's goals relating to enhancing its marketing strategies with respect to its customer base.

Referring again to FIG. 9, in some embodiments, the merchant transaction data may consist only of loyalty account profiles—i.e., may represent only transactions attached to loyalty accounts. In some embodiments, there may be another source of data (block 906) which may provide data for “unattached” transactions for the merchant of the kind referred to above. For example, the data provided by data source 906 may, in some embodiments, consist of network transaction data that corresponds to transactions performed at the merchant in question, and from which all attached transactions have been cleansed.

Block 908 represents an account linkage engine, which will be described in more detail below. The account linkage engine 908 may engage in one or more processes to improve the usefulness to the merchant of the merchant transaction data 904 and/or the other data 906 (if present). Block 910 represents a reporting engine. The reporting engine 910 may report results of analysis/processing by the account linkage engine 908. The reporting from the reporting engine 910 may, for example, be provided to one or more of: (a) one or more components of the system shown in FIG. 1; (b) the merchant; (c) another recipient of the reporting data; and (d) another computer or computers that perform one or more analyses of the data as processed by the account linkage engine 908.

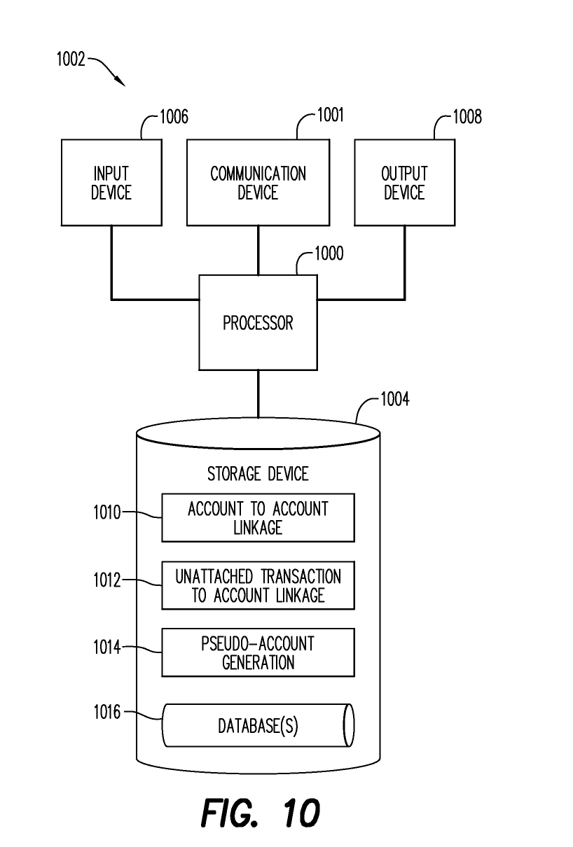

FIG. 10 is a block diagram depicting a computer system 1002 that may form part of the system 902 shown in FIG. 9. For example, the computer system 1002 may implement at least part of the account linkage engine 908 and/or other portions of the system 902.

The computer system 1002 may be conventional in its hardware aspects but may be controlled by software to cause it to operate in accordance with aspects of the present invention. For example, the computer system 1002 may be constituted, at least in part, by conventional mainframe and/or server computer hardware.

The computer system 1002 may include a computer processor 1000 operatively coupled to a communication device 1001, a storage device 1004, an input device 1006 and an output device 1008. The storage device 1004, the communication device 1001, the input device 1006 and the output device 1008 may all be in communication with the processor 1000.

The computer processor 1000 may be constituted by one or more conventional processors. Processor 1000 operates to execute processor-executable steps, contained in program instructions described below, so as to control the computer system 1002 to provide desired functionality.

Communication device 1001 may be used to facilitate communication with, for example, other devices (such as one or more other components of the systems shown in FIGS. 1 and/or 9). Communication device 1001 may, for example, have capabilities for engaging in data communication over conventional computer-to-computer data networks.

Input device 1006 may comprise one or more of any type of peripheral device typically used to input data into a computer. For example, the input device 1006 may include a keyboard and a mouse. Output device 1008 may comprise, for example, a display and/or a printer.

Storage device 1004 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory.

Storage device 1004 stores one or more programs for controlling processor 1000. The programs comprise program instructions that contain processor-executable process steps of computer system 1002, including, in some cases, process steps that constitute processes provided in accordance with principles of the present disclosure, as described in more detail below.

The programs may include one or more conventional operating systems (not shown) that control the processor 1000 so as to manage and coordinate activities and sharing of resources in the computer system 1002, and to serve as a host for application programs (described below) that run on the computer system 1002.

The programs stored in the storage device 1004 may also include a program or program module 1010 that controls the processor 1000 to enable the computer system 1002 to link together duplicate loyalty account profiles, as discussed further below. In addition, the storage device 1004 may store a program or program module 1012 that controls the processor 1000 to enable the computer system 1002 to link unattached transactions to loyalty account profiles, as will also be discussed below.

Still further, the storage device 1004 may a store a program or program module 1014 that controls the processor 1000 to enable the computer system 1002 to generate pseudo-loyalty-account profiles, as will also be discussed below.

The storage device 1004 may also store, and the computer system 1002 may also execute, other programs, which are not shown. For example, such programs may include a reporting application, which may respond to requests from system administrators for reports on the activities performed by the computer system 1002. The other programs may also include, e.g., one or more data communication programs, a database management program, device drivers, etc.

Reference numeral 1016 in FIG. 10 indicates one or more databases that are maintained by the computer system 1002 on the storage device 1004. Among these databases may be (a) a database/corpus of loyalty account profiles provided by the merchant; and (b) a database/corpus of unattached transactions performed at the merchant, and supplied by the merchant and/or derived from network transaction data. In some embodiments, some or all of the transaction data may be de-identified, in accordance with principles as described above.

The application programs of the computer system 1002 as described above, may be combined in some embodiments, as convenient, into one, two or more application programs.

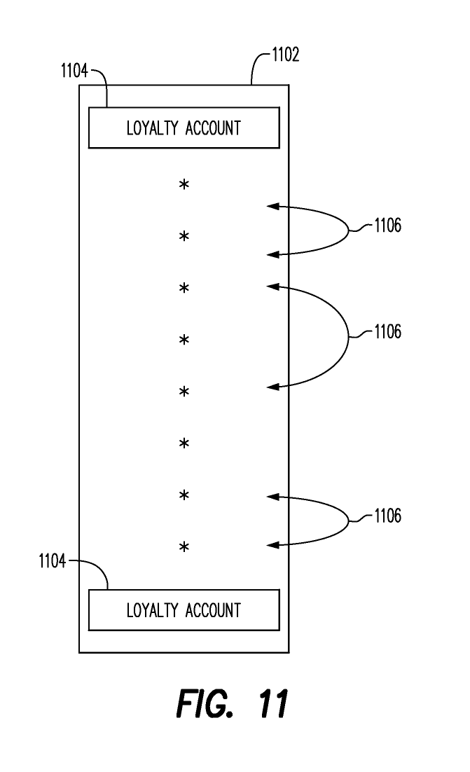

FIGS. 11-13 are diagrams that schematically illustrate processes/operations that may be performed by the computer system 1002 and/or in the system of FIG. 9 in some embodiments.

FIG. 11 schematically illustrates a corpus/database 1102 of loyalty account profiles 1104 generated/constructed by the merchant. Where the merchant is a large retailer with many store locations, the number of loyalty account profiles 1104 in the database 1102 may be very large, say in the hundreds of thousands or millions.

Each of the curved arrow marks 1106 in FIG. 11 respectively and schematically illustrates a linkage that may be made by the computer system 1002 between a respective pair of the loyalty account profiles 1104. The purpose of the linkages may be to combine loyalty accounts that are in fact duplicates—i.e., pairs of loyalty accounts that have been issued to the same individual or to the same household. In some embodiments, inferred match modeling may be employed to arrive at the linkages. In other embodiments, another type or types of matching may be employed. In some embodiments, a linkage between two loyalty account profiles may be based on analysis of network transaction data that indicates that the same payment account was used for transactions in both of the loyalty accounts that should be linked together. In some situations, there may be triplicate loyalty accounts or even more than three loyalty accounts that correspond to the same individual customer or household; in such situations three or more loyalty accounts may be linked to each other and combined.

Combining duplicate loyalty accounts may increase the usefulness and accuracy of the merchant's loyalty account data and may allow the merchant to achieve better understanding of their customers and the customers' shopping behavior, and may also enhance the types of analysis that may be performed using the loyalty account data.

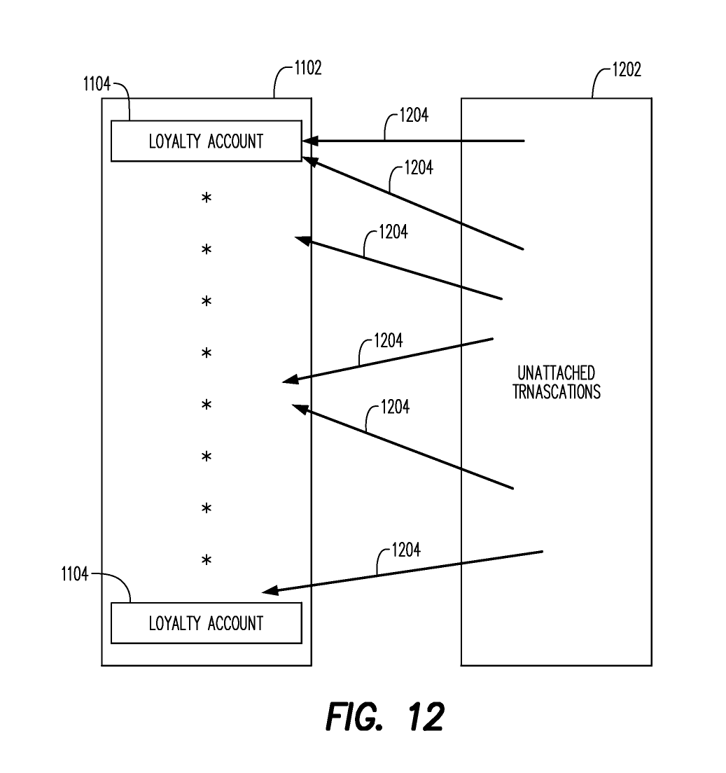

FIG. 12 again schematically shows the corpus/database 1102 of loyalty account profiles 1104. In some embodiments, the database 1102 may be taken to be in its condition after the linkage and combining of duplicate loyalty accounts as discussed above in connection with FIG. 11. Also shown in FIG. 12 is a corpus/database 1202 of unattached transaction data (i.e., representing payment account transactions performed at the merchant but not associated with any loyalty account). Each of arrow marks 1204 in FIG. 12 respectively and schematically illustrates a linkage that may be made by the computer system 1002 to link an individual unattached transaction from the database 1102 with one of the loyalty account profiles 1104. In some embodiments, inferred match modeling may be employed to arrive at the linkages. In other embodiments, another type or types of matching may be employed. In some embodiments, a linkage between an unattached transaction and a particular loyalty account profile may be based on analysis of network transaction data that indicates that the same payment account used for the unattached transaction was also used for at least one transaction or at least some transactions in the loyalty account to which the linkage is to be made. With respect to at least some of the loyalty accounts, it may be the case that more than one unattached transaction is linked to the loyalty account in question.

Linking unattached transactions to loyalty accounts (based on a reasonable inference that the individual customer who performed the unattached transaction is the/a holder of the loyalty account) may increase the usefulness and accuracy of the merchant's loyalty account data and may allow the merchant to achieve better understanding of their customers and the customers' shopping behavior. This may also enhance the types of analysis that may be performed using the loyalty account data.

In some embodiments, once an unattached transaction has been linked to one of the loyalty accounts, it may be removed from the database 1202 and may be deemed a linked transaction rather than an unattached transaction.

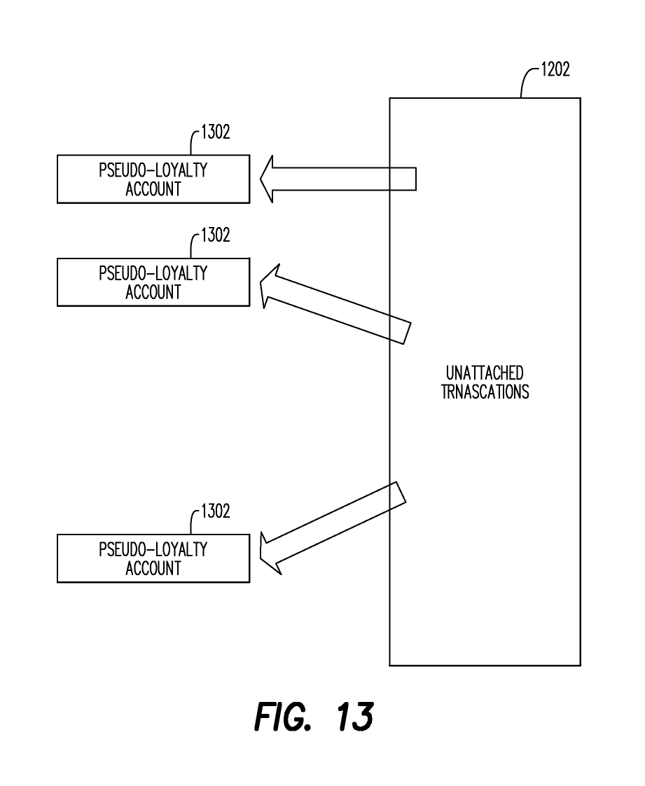

FIG. 13 shows the above-mentioned database 1202 of unattached transactions. In some embodiments, the condition of the database 1202 at the time of the operation illustrated in FIG. 13 may be such that it no longer includes (formerly) unattached transactions that have been linked to loyalty accounts.

FIG. 13 schematically shows pseudo-loyalty-account profiles 1302 formed from groups of unattached transactions in the database 1202. Each pseudo-loyalty-account profile 1302 may consist of all unattached transactions in the database 1202 that were performed using a particular payment account. In some embodiments, inferred match modeling may be employed to associate payment account numbers with the unattached transactions prior to the formation of the pseudo-loyalty-account profiles. In other embodiments, another type or types of matching may be employed. As will be seen, each pseudo-loyalty-account profile may represent the, or some of the, shopping activity of a particular customer of the merchant at the merchant, and may provide insight into the customer's shopping behavior even though the customer has not opted to participate in the merchant's customer loyalty program. Creation of the pseudo-loyalty-account profiles may make possible further analysis of the shopping behavior of the customers in question as if those customers had opted for participation in the customer loyalty account. In some embodiments, the identities of the relevant customers (i.e., those profiled by the pseudo-loyalty account profiles) may never become known to the merchant and also may not be tracked or ascertained by the payment network that provided the network transaction data. Nevertheless the pseudo-loyalty account profiles may have value in enhancing the merchant's understanding of its customers and their shopping behavior as a group and in supporting further analysis.

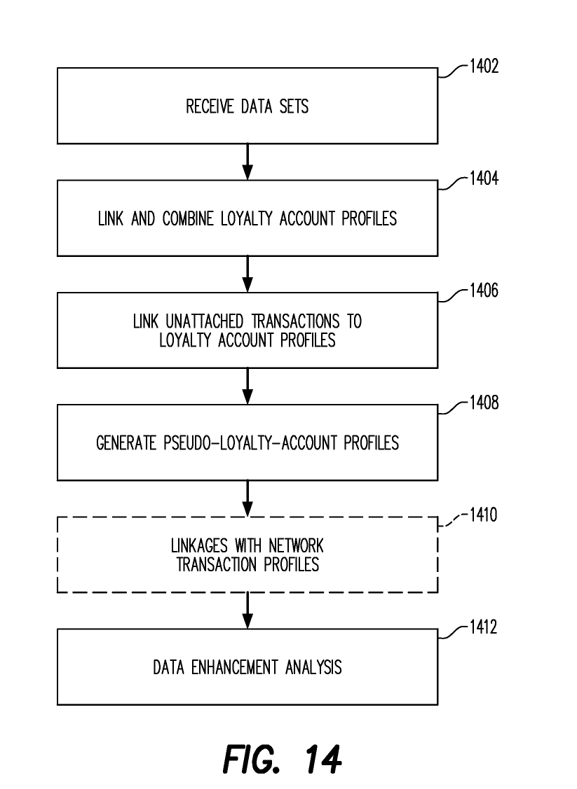

FIG. 14 is a flow chart that illustrates a process that may be performed in the system of FIG. 9 in some embodiments.

At 1402, the computer system 1002 may receive one or more data sets, including data sets as described above, such as the customer loyalty account profile database 1102 and/or the unattached transaction database 1202, as described above in connection with FIGS. 11-13.

At 1404, the computer system 1002 may link and combine duplicate loyalty account profiles, as described above in connection with FIG. 11.

At 1406, the computer system 1002 may link individual unattached transactions to loyalty account profiles, as described above in connection with FIG. 12.

At 1408, the computer system 1002 may form pseudo-loyalty-account profiles as described above in connection with FIG. 13.

In some embodiments, one or more of the process steps 1404, 1406 and 1408 may be omitted.

In some embodiments, at 1410, the processed loyalty account profiles and/or the pseudo-loyalty-account profiles may be subjected to inferred match modeling processing/linkage with network transaction profiles, as generally described above with reference to FIGS. 1-8.

At 1412, by using the linkages, combined and/or enhanced loyalty account profiles, and/or pseudo-loyalty account profiles produced at steps 1404, 1406 and/or 1408 and/or the linkages with network transaction data, one or more of various enhanced data analyses may be performed by the computer system 1002 or by another computer (not shown in FIG. 9) which may receive one or more outputs from the computer system 1002. By way of example, the enhanced data analysis or analyses may include a “share of wallet” analysis or a frequency of visits analysis, both of which terms are familiar to those who are skilled in the art. Further description of “share of wallet” analysis and/or other analyses that may be performed at 1412 is contained in commonly assigned U.S. patent application Ser. No. 14/169,749, filed Jan. 31, 2014, published at U.S. Patent Publication No. 2015/______ (atty docket no. M01.263), and which is incorporated herein by reference. As is familiar to those who are skilled in the art, a share of wallet analysis may indicate what percentage of the customer's or customers' purchases among a group of retailers or in a given merchant category or categories are made at a particular merchant. A frequency of visits analysis may indicate how often a customer or customers visit a merchant's retail store locations.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable, including simultaneous performance of at least some steps.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A computerized method, comprising:
receiving a first set of transaction data from a merchant, the first set of transaction data representing a plurality of customer profiles, each of said customer profiles corresponding to a respective account in a customer loyalty program administered by the merchant;
receiving a second set of transaction data, the second set of transaction data representing unattached transactions involving the merchant but not associated by the merchant with any of said customer loyalty program accounts; and
using payment account numbers associated with the unattached transactions to link ones of said unattached transactions to respective ones of said customer loyalty program accounts.

2. The method of claim 1, further comprising:
using payment account numbers associated with said customer profiles to link ones of said customer profiles with each other.

3. The method of claim 1, wherein:
said ones of said unattached transactions linked to ones of said customer loyalty program accounts are linked transactions;
the method further comprising:
using payment account numbers associated with unattached transactions that are not linked transactions to form pseudo-customer-profiles from ones of the unattached transactions that are not linked transactions.

4. The method of claim 3, wherein, for each of said pseudo-customer-profiles, all transactions forming the respective pseudo-customer-profile share a common one of the payment account numbers.

5. The method of claim 1, further comprising:
performing a share-of-wallet analysis with respect to said ones of said customer loyalty program accounts, said share-of-wallet analysis reflecting said unattached transactions linked to said ones of said customer loyalty program accounts.

6. The method of claim 1, further comprising:
performing a frequency-of-visit analysis with respect to said ones of said customer loyalty program accounts, said frequency-of-visit analysis reflecting said unattached transactions linked to said ones of said customer loyalty program accounts.

7. The method of claim 1, wherein said received first and second sets of transaction data consist of de-identified data.

8. The method of claim 1, wherein said transaction data represents payment account transactions accepted by the merchant.

9. A computerized method, comprising:
receiving a set of transaction data from a merchant, the set of transaction data representing a plurality of customer profiles, each of said customer profiles corresponding to a respective account in a customer loyalty program administered by the merchant; and
using payment account numbers associated with said customer profiles to link ones of said customer profiles with each other.

10. The method of claim 9, further comprising:
forming combined customer profiles, each of said combined customer profiles formed from at least two of said customer profiles that have been linked to each other.

11. The method of claim 10, further comprising:
performing a share-of-wallet analysis with respect to the combined customer profiles.

12. The method of claim 10, further comprising:
performing a frequency-of-visit analysis with respect to the combined customer profiles.

13. The method of claim 9, wherein said received set of transaction data consists of de-identified data.

14. The method of claim 9, wherein said transaction data represents payment account transactions accepted by the merchant.

15. A computerized method, comprising:
receiving a first set of transaction data from a merchant, the first set of transaction data representing a plurality of customer profiles, each of said customer profiles corresponding to a respective account in a customer loyalty program administered by the merchant;
receiving a second set of transaction data, the second set of transaction data representing unattached transactions involving the merchant but not associated by the merchant with any of said customer loyalty program accounts; and
using payment account numbers associated with unattached transactions to form pseudo-customer-profiles.

16. The method of claim 15, wherein said pseudo-customer-profiles are not linked to said customer profiles represented by said first set of transaction data.

17. The method of claim 15, wherein, for each of said pseudo-customer-profiles, all transactions forming the respective pseudo-customer-profile share a common one of the payment account numbers.

18. The method of claim 15, further comprising:
performing a share-of-wallet analysis with respect to the pseudo-customer-profiles.

19. The method of claim 15, further comprising:
performing a frequency-of-visit analysis with respect to the pseudo-customer-profiles.

20. The method of claim 15, wherein said received first and second sets of transaction data consist of de-identified data.
